(19) United States
(12) Patent Application Publication
(10) Pub. No.: US 2025/0068940 A1
(43) Pub. Date: Feb. 27, 2025

(54) PREDICTION USING GENERATED SEMANTIC STORIES

(71) Applicant: International Business Machines Corporation, Armonk, NY (US)

(72) Inventors: Segev SHLOMOV, Haifa (IL); Alon OVED, Haifa (IL); Sergey ZELTYN, Haifa (IL); Nir MASHKIF, Geva Carmel (IL)

(21) Appl. No.: 18/455,162

(22) Filed: Aug. 24, 2023

(51) Int. Cl. G06N 5/022

(52) U.S. Cl. CPC G06N 5/022

(57) ABSTRACT

An example system includes a processor to receive an event trace. The processor can transform the event trace into a semantic story using a generated story template. The processor can input the semantic story into a fine-tuned model. The processor can receive a next skill prediction from the fine-tuned model.

### BACKGROUND

The present techniques relate to predictive process monitoring (PPM). More specifically, the techniques relate to the execution of predictive tasks in PPM.

Intelligence Process Automation (IOA) is a technique that combines classical BPM. RPA, chatbots and orchestration tools. IPA event logs can contain user utterances, bot responses and additional textual semantic information. An event log, as used herein, refers to a set of all traces. A trace, as used herein, refers to a sequence of events or activities.

In Robotic Process Automation (RPA), a chatbot user interface (UI) may include a text input control for user utterances, a messaging-like area to present the chatbot response, and a history of a conversation with a user. For example, in a typical interaction pattern, a user may provide an initial utterance that is classified into an intent and then triggers the right RPA automation. The RPA automation can perform a task, including collecting additional parameters from the user via the same conversational channel. The task of predicting the next automation, or skill, to be used by the user is referred to herein as next skill prediction. In the specific use case of business process management (BPM), this task is related to the task of predicting the next activity in a process. That is, given an event log and a current trace of the process, the task may be to predict the next activity that the user will perform.

In the RPA domain, the trace of the user-bot interaction also includes the utterances that the user used in order to invoke the automation skill and the utterances that the bot used in order to respond to the user. These utterances have a semantic meaning, which might provide valuable information to the task of next skill prediction. Moreover, the history of the user-bot interaction can also help in better predictions.

The task of predicting the next skill may serve as a platform for recommending the next best skill. For example, in conversational RPA bots, which include a larger set of automation skills, it may be very difficult for a user to understand what the bot is capable of doing in general, what new useful orchestrations might be worth trying out, what are the best next steps to engage the bot to move the process forward, as well as what not to ask. This difficulty may yield an error and result in frustration. In that case, next skill prediction may be used to recommend to the user what other users did in the same situation.

Predictive process monitoring is used to gain predictive insights on the future of a process instance given historical event logs and instance past information, referred to herein as a prefix. There are many methods for solving the task of next activity or skill prediction. Some solutions solve this problem by training a deep learning classifier. Examples include training long short-term memory networks (LSTMs), gated recurrent units (GRU), differentiable neural computer (DNC), Deep Feed-Forward Neural Network (DFNN), convolutional neural network (CNN), recurrent neural network (RNN) classifiers.

Some other machine learning solutions use various machine learning methods, such as a tree-based classifier. For example, example machine learning methods include training a classifier using Random Forest, XgBoost, CatBoost, Logistic Regression, support vector machines (SVM), Naïve Bayes (NB), or decision trees (DT). These approaches achieve limited results as they do not capture the semantics of the skills and the semantic connection between the skills and the utterances. Moreover, such machine learning methods may not work well with sequential data and may also make it hard to incorporate free-text features.

Transformer based methods offer the benefit of an attention mechanism. Examples of transformers include Left2Right Transformers, Bidirectional Transformer, and Process Transformer.

### SUMMARY

According to an embodiment described herein, a system can include processor to receive an event trace. The processor can also further transform the event trace into a semantic story using a generated story template. The processor can also input the semantic story into a fine-tuned model. The processor can then receive a prediction from the fine-tuned model. Thus, the system enables efficient and accurate task prediction using automatically generated semantic stories. Preferably, the event trace includes an ordered set of skills. In this embodiment, the system enables next skill prediction. Preferably, the model includes a paragraph-based language classifier. In this embodiment, the system enables efficient training and task prediction. Preferably, the processor is to receive event logs, extract traces from the event logs, generate the story template based on the extracted traces, transform each trace into semantic stories based on the story template, and fine-tune the model based on the semantic stories. Preferably, the story template includes an ordered list of skills connected with a connective word. In this embodiment, the system enables efficient automated story generation. Preferably, the connective word includes an adverb that describes a sequence and a position of the connected skills. In this embodiment, the system enables efficient automated story generation. Preferably, the features include free text features. In this embodiment, the system enables the efficient and accurate processing of free text features in task prediction. Optionally, the prediction includes a next skill prediction. In this embodiment, the system enables efficient and accurate next skill prediction.

According to another embodiment described herein, a method can include receiving, via a processor, event logs. The method can further include extracting, via the processor, traces from the event logs. The method can also further include generating, via the processor, a story template based on the extracted traces. The method can also include transforming, via the processor, each trace into semantic stories based on the story template. The method can further include fine-tuning, via the processor, a model for a prediction task based on the semantic stories. Thus, the method enables the efficient training of a machine learning model for prediction tasks using semantic stories. Preferably, fine-tuning the model includes using the semantic stories as samples and a detected next activity as a label for each of the samples. In this embodiment, enables efficient automated training of the model. Optionally, the prediction task includes a next skill prediction. In this embodiment, enables efficient training for next skill prediction. Optionally, the method includes generating a number of story templates and fine-tuning the model using the number of story templates, where the number of story templates include different features. In this embodiment, multiple story templates may enable different types of databases or tasks to be processed. Preferably, the story template includes an ordered list of skills connected with a connective word. In this embodiment, story templates may be efficiently generated. Preferably, the story template includes an ordered list of skills connected by an adverb that describes a sequence and a position of the connected skills. In this embodiment, effective story templates may be efficiently generated. Optionally, the method includes receiving a current event trace, transforming the current event trace into a semantic story using the generated story template, inputting the semantic story into a fine-tuned model, and receiving a next skill prediction from the fine-tuned model. In this embodiment, the method may efficiently execute a next skill prediction.

According to another embodiment described herein, a computer program product for training machine learning models can include computer-readable storage medium having program code embodied therewith. The program code executable by a processor to cause the processor to receive event logs. The program code can also cause the processor to extract traces from the event logs. The program code can also cause the processor to generate a story template based on the extracted traces. The program code can also cause the processor to transform each trace into semantic stories based on the story template. The program code can also cause the processor to fine-tune a model for a prediction task based on the semantic stories. Thus, the computer program product enables efficient training for task prediction using semantic stories. Optionally, the program code can also cause the processor to also further receive an event trace, transform the event trace into a semantic story using a generated story template, input the semantic story into a fine-tuned model, and receive a prediction from the fine-tuned model. In this embodiment, the method includes using the fine-tuned model to efficiently and accurately execute prediction tasks. Optionally, the prediction includes a next skill prediction. In this embodiment, the method enables efficient and accurate next skill prediction. Preferably, the program code can also cause the processor to generate the story template by connecting an ordered list of skills with a connective word. In this embodiment, effective story templates may be efficiently generated. Optionally, the program code can also cause the processor to generate an additional story template in response to detecting that a trace includes a different feature. In this embodiment, the program product enables different features to be efficiently incorporated into the training and prediction.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a semantic story based prediction module;

FIG. 2 is an example tangible, non-transitory computer-readable medium that can train a classifier to classify event traces using semantic stories;

FIG. 3 is a process flow diagram of an example method that can train a classifier to classify event traces using semantic stories;

FIG. 4 is a process flow diagram of an example method that can classify event traces using semantic stories;

FIG. 5 is a block diagram of an example system for training a classifier to classify event traces using semantic stories;

FIG. 6 is an example process generating a story template generated from input event log; and

FIG. 7 is a table depicting accuracy results of a sample embodiment of the techniques described herein.

### DETAILED DESCRIPTION

As described above, deep learning methods and transformers are sometimes used to predictive process monitoring. However, these deep learning methods may require a lot of data and are most powerful in cases where most features are numerical. Moreover, deep learning methods may make difficult to incorporate free-text features, may not offer long-term dependencies, and also not offer semantics of the features's values. Moreover, it may also be hard to incorporate free-text features into transformer based methods, as well as include many features. Nor do transformers provide semantics of the attribute's values.

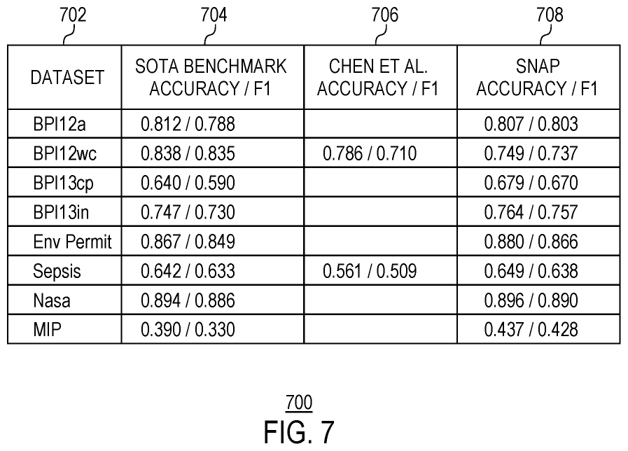

According to embodiments of the present disclosure, predictive process monitoring tasks are handled via semantic stories. The embodiments include an improved method for solving predictive tasks, such as the next best skill prediction problem. In particular, semantic stories are built from event logs and then used for predictive tasks. As used herein, an event log is a set of traces, where a trace is an order list of events or skills with their corresponding features. Example features for events include time stamps, role, activity, and user utterance. Skills may include features such as who performed them, what was the trigger, at what stage of the conversation the skills appear, etc. As one example, given an event log, each prefix trace extracted from the event log is transformed into a coherent semantic story based on the feature name and values, and the history of past events. As used herein, a prefix trace refers to a subsequence of first k events in a trace. Then, a model is fine-tuned to receive stories and output predictions. For example, the language-based foundation model to be fine-tuned may be the Bidirectional Encoder Representations from Transformers (BERT) language representation model, first introduced 2018, or the Robustly Optimized BERT Pretraining Approach (ROBERTa) model, released in 2019 by Liu et al. Via the semantic stories, the techniques herein thus capture the semantics of all features (including free-text, categoric, and numeric) and the connection between the attributes' names to each other and to other attributes' values via one story. Thus, embodiments of the present disclosure enable identification of the connection and the order between the skills themselves and between the skills and the other features, such as the utterances and the current turn number. Moreover, the embodiments enable such predictions without having to detect intent, and are thus different from solutions that attempt to detect an intent or skill that best fits a given user utterance. Finally, when tested on the MIP dataset, the results suggest significant improvement compared to the current state of the art. Moreover, improvement was shown as compared to a naïve solution that uses average word embedding of the words in a trace. Some results of testing are shown and described in greater detail with respect to FIG. 7. The techniques described herein are thus highly flexible and can be implemented in many variations and in a variety of use cases.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a semantic story based prediction module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

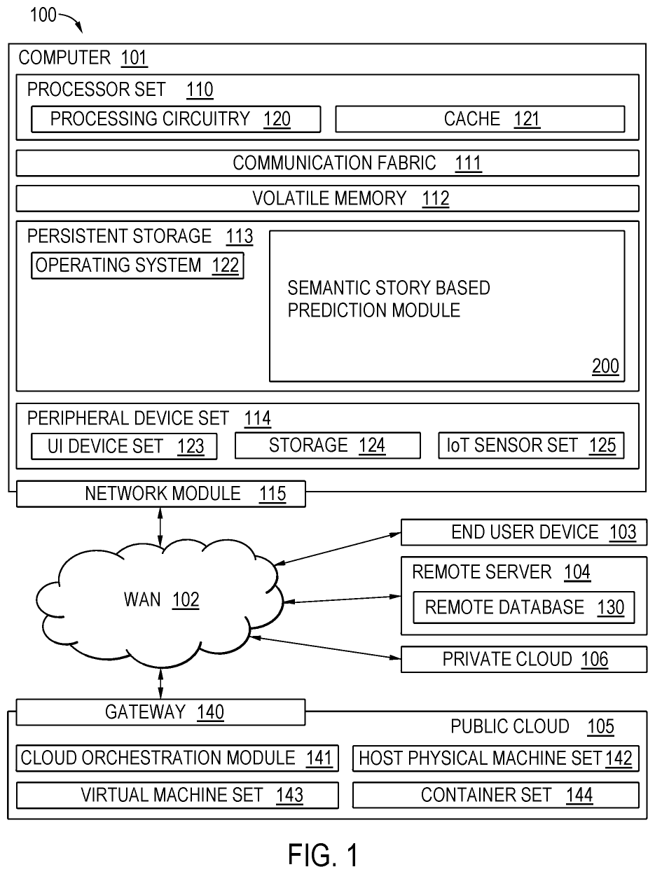

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

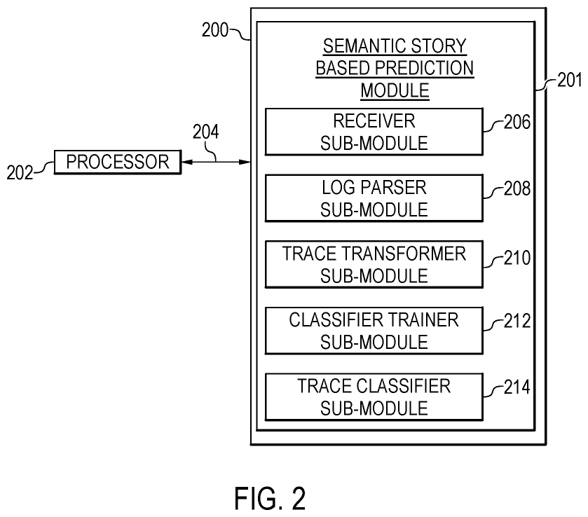

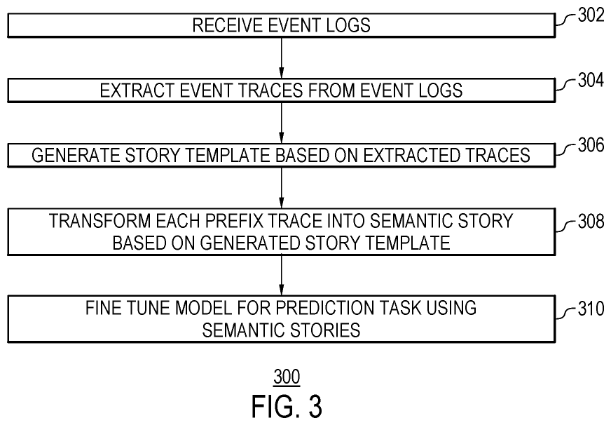

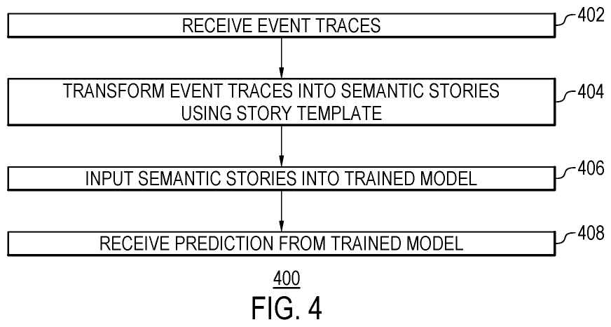

Referring now to FIG. 2, a block diagram is depicted of an example tangible, non-transitory computer-readable medium 201 that can train a classifier to classify event traces using semantic stories. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the methods 300 and 400 of FIGS. 3 and 4.

The various software components discussed herein may be stored on the tangible, non-transitory, computer-readable medium 201, as indicated in FIG. 2. For example, a receiver module 206 includes code to receive event logs. The receiver module 206 also includes code to receive event traces. A log parser module 208 includes code to extract traces from the event logs. A trace transformer module 210 includes code to generate a story template based on the extracted traces. For example, the trace transformer module 210 includes code to generate the story template by connecting an ordered list of skills with a connective word. In some examples, the trace transformer module 210 includes code to generate an additional story template in response to detecting that a trace includes a different feature. In various examples, the trace transformer module 210 includes code to generate a story template for each database or each different domain. The trace transformer module 210 also includes code to transform traces into semantic stories based on the story template. A classifier trainer module 212 includes code to fine-tune a model for a prediction task based on the semantic stories. A trace classifier module 214 includes code to input the semantic story into a fine-tuned model and receive a prediction from the fine-tuned model. For example, the prediction may be a next skill prediction. In various examples, the prediction may be a path or suffix prediction, remaining time prediction or outcome prediction, among other types of prediction.

It is to be understood that any number of additional software components not shown in FIG. 2 may be included within the tangible, non-transitory, computer-readable medium 201, depending on the specific application.

FIG. 3 is a process flow diagram of an example method that can train a classifier to classify event traces using semantic stories. The method 300 can be implemented with any suitable computing device, such as the computer 101 of FIG. 1. For example, the methods described below can be implemented by the processor set 110 of FIG. 1.

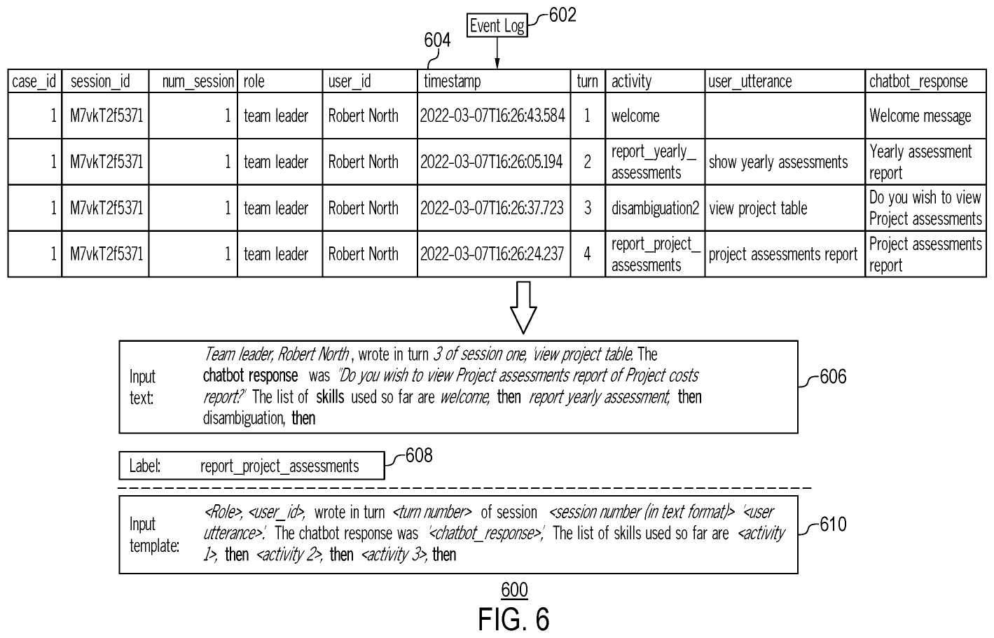

At block 302, event logs are received. Each event log may include all the events in a particular session along with features and their values up to a current point in time. As one example, the event logs may be intelligence process automation (IPA) event logs that contain user utterances, bot responses and additional textual semantic information. An example event log with various features and their values for four turns is shown in FIG. 6.

At block 304, event traces are extracted from the event logs. For example, each of the event traces may be an ordered set of skills.

At block 306, a story template is generated based on the extracted traces. In various examples, a basic story template can be automatically generated. For example, the basic story template can be automatically generated using a generative language model, such as a chat-based generative language model. In some examples, the basic story template can be generated by inputting the extracted traces and previously used story templates into the chat model along with a prompt to generate a similar story template for the extracted traces. In various examples, the story template may be generated based on features and their values of the extracted traces. For example, the features may include free text features, such as words and sentences, or numbers, and categorical features, among other types of features, or any combination thereof. In some examples, other features, such as numbers, may be similarly processed to generate the story template. As one example, the story template may be an ordered list of skills connected with a connective word. For example, the ordered list of skills may be connected by an adverb that describes a sequence and a position of the connected skills. In some examples, a story template may be generated for each different domain. In some examples, a story template may be generated per database or dataset. In various examples, any number of story templates including different features may be generated. In some examples, the story template may be generated using consultation with domain experts. For example, a set of story templates may be generated in advance for a predetermined number of different domains, such as 10 different domains.

At block 308, each prefix trace is transformed into semantic story based on generated story template. In various examples, each trace in the event log may include a number of prefix traces. For example, each prefix trace may be associated with a particular turn and may include all turns up to and including the particular turn. In this manner, tabular data is converted into free text that can be used to fine tune a language model. In some examples, prefix traces from different event logs of different domains may be transformed using the same or different story templates. For example, prefix traces with different features may be transformed with story templates that include such features.

At block 310, a model is fine tuned for a prediction task using semantic stories. In various examples, the model may be any suitable language-based foundational model. For example, the language-based foundation model to be fine-tuned may be a BERT based model, such as the original BERT model or the ROBERTa model, among other suitable models that can process free text. In various examples, the generated stories may be used as samples for training and the detected next activity following each of the samples may be used as labels. In some embodiments, the prediction task may be a next activity or next skill prediction. In various examples, the prediction task may alternatively, or additionally, be path or suffix prediction. As used herein, suffix prediction refers to the prediction of future events. In some examples, the prediction task may alternatively, or additionally, be remaining time prediction or outcome prediction, or trace suffix prediction tasks, among other types of predictive tasks. In some examples, the model can be fine tuned using stories generated using a variety of story templates based on different types of event logs. For example, the stories may have different sets of features based on the different story templates and corresponding event logs from potentially different domains.

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, in some embodiments, the method 300 may include generating additional story templates for skills having different features. However, in the case of conversational bots, for example, the features of skills may be similar such that the story template generated at block 304 may be used at block 306 to transform traces with any number of various skills.

FIG. 4 is a process flow diagram of an example method that can classify event traces using semantic stories. The method 400 can be implemented with any suitable computing device, such as the computer 101 of FIG. 1. For example, the methods described below can be implemented by the processor set 110 of FIG. 1.

At block 402, event traces are received. For example, the event traces may be ordered sets of skills or activities.

At block 404, the event traces are transformed into semantic stories using a story template. For example, the story template may be the same story template that was generated and used for training the model, as described in method 300 of FIG. 3. In some examples, the story generated may be a different than the general story template used to train the model. For example, a specific trace can have less attributes involved, making the corresponding story a bit different to the general template.

At block 406, the generated semantic stories are input into a trained model. For example, the model may be a language-based foundation model, such as a paragraph-based language classifier, that was fine-tuned using the method 300 of FIG. 3.

At block 408, predictions are received from the trained model. For example, each prediction may be a predicted next skill for a given input event trace. In various examples, the predictions may alternatively, or additionally be, a path or suffix prediction, or a remaining time prediction or outcome prediction, among other types of prediction

The process flow diagram of FIG. 4 is not intended to indicate that the operations of the method 400 are to be executed in any particular order, or that all of the operations of the method 400 are to be included in every case. Additionally, the method 400 can include any suitable number of additional operations.

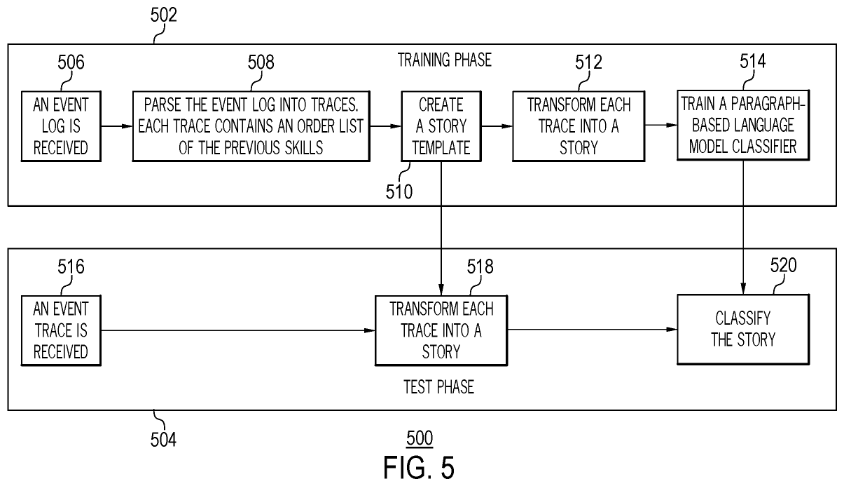

With reference now to FIG. 5, a block diagram shows an example system for training a classifier to classify event traces using semantic stories. The example system 500 of FIG. 5 includes a training phase 502 and a test phase 504. The training phase 502 includes, at block 506, receiving an event log. For example, the event log may be a temporally ordered set of events.

In the example of FIG. 5, the system 500 can transform typical next-best skill and activity input data into a short semantic story and uses the semantic meaning of the story for the prediction of the next skill. The input of our method is the event-log and the current trace of the users while the output is a prediction of the next best skill.

At block 506 of training phase 502, an event log is received. For example, the event log may be a list of user utterances and associated chat bot responses for a session temporally ordered and organized by turns. Given the event log, at block 508, the data from the event log is parsed into traces. For example, each trace is represented by a sample, which includes a list of features extracted from the event log. The label of a sample is defined as the next skill in the trace.

At block 510, a single template story is constructed that can logically describes the meaning of the process. For example, a basic story template may be automatically generated. In some examples, additional features to be included in the story template may be received. For example, the additional features may be received from a domain expert or user that has consulted with a domain expert.

At block 512, each trace is transformed into a story using the story template. For example, the template story is applied to each sample to generate a story for each prefix trace. In various examples, the trace is a prefix trace, in which the first K events in a trace is a prefix where the prediction task is to predict the activity of the K+1 event.

At block 512 a paragraph-based language foundation model is trained for the prediction task based on the new stories. For example, the paragraph-based language foundation model may be a pre-trained BERT model or the ROBERTa model.

In test phase 504, at block 516, an event trace is received. For example, the event trace may include an ordered set of skills up to a current point in time.

At block 518, when the prediction of the next skill is to be executed at runtime, the story template is applied on the current trace received at block 516 to transform the trace into a story. For example, the story template may be the same story template generated at block 510. In some examples, a different story template may also be alternatively used at runtime.

At block 520, each story is classified. For example, the previously trained classifier from block 514 of training phase 502 may be used for the prediction of the next skill. In some examples, the story may be used to predict path or suffix prediction, a remaining time prediction or an outcome prediction, among other types of prediction.

It is to be understood that the block diagram of FIG. 5 is not intended to indicate that the system 500 is to include all of the components shown in FIG. 5. Rather, the system 500 can include fewer or additional components not illustrated in FIG. 5 (e.g., additional event logs, event traces, or additional story templates, classifier, stories, classification, etc.).

FIG. 6 is an example process generating a story template generated from an input event log. The process includes access a full event log 602 and extracting a sample 604 from the event log 602 including several events. In the example of FIG. 6, four events have been extracted for a prefix trace of three events, where the task is to predict the activity from the 4th event shown in the last row of sample 604. For example, the session may be a human resources (HR) use case. In an example use case, a user talks with the WO in order to create and check reports. In the sample 604, Trace 1 corresponds to the first row, Trace 2 corresponds to the first and the second row, and so on. The last skill in the second trace is report_yearly_assessments. The report_yearly_assessments skill was triggered by a team leader since she wrote: “show me the yearly assessment report please.”

Given an event log sample 604 and a current trace, the task for process 600 is to predict the next skill to be performed by the user. To do so, the process 600 may construct a story template 610 that represents the flow of the given traces based on their features. For example, given the list of features: role, user id, turn number, user utterance, and chatbot response the process 600 constructed the following template 610:

<Role> <use_id>, wrote in turn <turn number> of session
<session number (in text format)> ‘<user_utterance>’. The chatbot
response was ‘<chatbot_response>,’ The list of skills used so far
are <activity 1>, then <activity 2>, then <activity 3>, . . . then . . .

It was found that ordering the skills in the trace and the word “then” gives meaning to the sequence of skills and to the position of each skill in the trace. Thus, the trained model is able to learn better what is the next skill to be performed with such meaning. In some embodiments, the process 600 may construct a template for each different type of use case. For example, use cases having different features or skills may benefit from having a custom story template. However, it was found that the features in different use cases of RPA system used in the example of FIG. 6 were relatively the same. For example, the features included name, role, utterance, response, turn, etc. Thus, the process 600 can be easily implemented using a similar story template in many use cases and variations. Applying the above story template to Trace 3 corresponding to turn 3 (k=3), which includes the last three activities and their features, yields the following story for Trace 3:

The team leader Robert North wrote in turn 3 of session one,
‘view project table. ’ The chatbot response was ‘Do you wish to
view Project assessments report of Project costs report?’. The list
of skills used so far is welcome, then report yearly assessment,
then disambiguation2, then, . . .

The label 608 of the above trace 3 may be ‘Report_project_assessments because this label 608 corresponds to the next skill the user performs in row 4, which the model is to be trained to predict. Via the above single semantic story, the process 600 captures the semantics of all features (including free-text, categoric, and numeric features) and the connection between the attributes' names to each other and to other attributes' values.

After transforming each trace into a pair of a story 606 and a label 608, a list of pairs may be used to train a paragraph-based language classifier. For example, the paragraph-based language classifier to be fine-tuned may be the BERT or ROBERTa classifier.

At the test stage, given a new trace, the story template 610 is used to transform the new trace into a story. Thereafter, the new story is input into the trained classifier to predict the next best skill. The trained classifier may return the next best skill accordingly.

It is to be understood that the block diagram of FIG. 6 is not intended to indicate that the process 600 is to include all of the components shown in FIG. 6. Rather, the process 600 can include fewer or additional components not illustrated in FIG. 6 (e.g., additional event logs, event traces, or additional story templates, story template components, classifier, stories, classification, etc.). In various examples, the story template may additional have additional features, such as numerical or categorical features. For example, the story template could have timestamps added.

As another specific example, the following example story may be generated using a story template that includes the resource of each past activity:

Loan amount of 10000 was requested 1 day ago. Activity ‘pre-
accept application that requires additional information’ was
performed in turn 3 by resource 12. Sequence of activities: submit
application by resource 12, then partly submit application by
resource 12, then pre-accept application that requires additional
information by resource 4.

Thus, a story template can be easily modified to incorporate information about features of previous activities, such as the resource of each past activity. In some examples, temporal data can also be incorporated into a story template. For example, the resulting story may describe: “the loan amount of 10000 was requested on Sun, Feb. 4, 2023, at 11:25 AM.” In various examples, a determination as to which features are to be included may be made. For example, the determination may be manually made in response to consulting with a domain expert. In various examples, a basic story template may be automatically generated.

FIG. 7 is a table depicting accuracy results of a sample embodiment of the techniques described herein. The table 700 includes a set of datasets 702, including BPI12a, BPI12wc, BPI13cp, BPI13in, Env Permit, Sepsis, Nasa, accessed from the 4TU.ResearchData website, and the MIP dataset used in the paper Prescriptive Process Monitoring in Intelligent Process Automation with Chatbot Orchestration, by Sergey et al. BPI in this context refers to Business Process Intelligence and these datasets come from a common challenge track related to the Business Process Management (BPM) conference. The table 700 also includes a state of the art (SOTA) benchmark 704 for accuracy and F1 score, which shows the results of using the best SOTA solution for each dataset, whichever solution this may have been for each particular dataset. The table 700 also further includes a second benchmark 706 based on Multi-task prediction method of business process based on BERT and Transfer Learning, by Chen et al., released October 2022. The table 700 also further includes the results of a Semantic stories for Next Activity Prediction (SNAP) implementation of the techniques described herein.

As shown in FIG. 7, the techniques described herein resulted in an approximately 2-10% improvement over the SOTA for most of the datasets 702 that were experimented with. Although the techniques described herein were shown to work well for classical BPM datasets, they can provide a larger improvement margin for IPA datasets.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive an event trace;
transform the event trace into a semantic story using a generated story template;
input the semantic story into a fine-tuned model; and
receive a prediction from the fine-tuned model.

2. The system of claim 1, wherein the event trace comprises an ordered set of skills.

3. The system of claim 1, wherein the model comprises a paragraph-based language classifier.

4. The system of claim 1, wherein the processor is to:
receive event logs;
extract traces from the event logs;
generate the story template based on the extracted traces;
transform each trace into semantic stories based on the story template; and
fine-tune the model based on the semantic stories.

5. The system of claim 1, wherein the story template comprises an ordered list of skills connected with a connective word.

6. The system of claim 5, wherein the connective word comprises an adverb that describes a sequence and a position of the connected skills.

7. The system of claim 1, wherein the features comprise free text features.

8. The system of claim 1, wherein the prediction comprises a next skill prediction.

9. A computer-implemented method, comprising:
receiving, via a processor, event logs;
extracting, via the processor, traces from the event logs;
generating, via the processor, a story template based on the extracted traces;
transforming, via the processor, each trace into semantic stories based on the story template; and
fine-tuning, via the processor, a model for a prediction task based on the semantic stories.

10. The computer-implemented method of claim 9, wherein fine-tuning the model comprises using the semantic stories as samples and a detected next activity as a label for each of the samples.

11. The computer-implemented method of claim 9, wherein the prediction task comprises a next skill prediction.

12. The computer-implemented method of claim 9, comprising generating a plurality of story templates and fine-tuning the model using the plurality of story templates, wherein the plurality of story templates comprise different features.

13. The computer-implemented method of claim 9, wherein the story template comprises an ordered list of skills connected with a connective word.

14. The computer-implemented method of claim 9, wherein the story template comprises an ordered list of skills connected by an adverb that describes a sequence and a position of the connected skills.

15. The computer-implemented method of claim 9, further comprising:
receiving a current event trace;
transforming the current event trace into a semantic story using the generated story template;
inputting the semantic story into a fine-tuned model; and
receiving a next skill prediction from the fine-tuned model.

16. A computer program product for training machine learning models, the computer program product comprising a computer-readable storage medium having program code embodied therewith, the program code executable by a processor to cause the processor to:
receive event logs;
extract traces from the event logs;
generate a story template based on the extracted traces;
transform each trace into semantic stories based on the story template; and
fine-tune a model for a prediction task based on the semantic stories.

17. The computer program product of claim 15, further comprising program code executable by the processor to:
receive an event trace;
transform the event trace into a semantic story using a generated story template;
input the semantic story into a fine-tuned model; and
receive a prediction from the fine-tuned model.

18. The computer program product of claim 16, wherein the prediction comprises a next skill prediction.

19. The computer program product of claim 16, further comprising program code executable by the processor to generate the story template by connecting an ordered list of skills with a connective word.

20. The computer program product of claim 16, further comprising program code executable by the processor to generate an additional story template in response to detecting that a trace comprises a different feature.
